(19) United States
(12) Patent Application Publication
(10) Pub. No.: US 2013/0066962 A1
(43) Pub. Date: Mar. 14, 2013

(54) METHOD AND APPARATUS FOR SOCIAL NETWORK

(71) Applicants: Philip Scherzinger, Staten Island, NY (US); Intiaz Bacchus, Fords, NJ (US)

(72) Inventors: Philip Scherzinger, Staten Island, NY (US); Intiaz Bacchus, Fords, NJ (US)

(21) Appl. No.: 13/228,952

(22) Filed: Sep. 9, 2011

(51) Int. Cl. G06F 15/16

(52) U.S. Cl. 709/204

(57) ABSTRACT

A system that creates an online social network platform that models a person's real life. This social network may reproduce the way users communicate and share information in their real “offline” life. Just as users create offline social circles of people they know, with each circle having varying limited knowledge of a person's personal information, the system allows users to create personal social circles online. Additionally, just as users most often belong to real life public circles through association as in work, school or residency, the system will foster and maintain such communication online.

### FIELD OF THE INVENTION

This invention relates to improved methods and apparatus concerning social networks using the internet.

### BACKGROUND OF THE INVENTION

There are various devices known as social networks, such as “Facebook” (trademarked) and “MySpace” (trademarked). In these social networks, virtual environments are created that are not realistic or linked to a person's real life. As an example, if a user adds their spouse or a long lost high school classmate, they both have equal access to all of a person's information. When we communicate with our friends on these social networks, all other friends are able to participate, regardless of their relationship. As a result, communication to a close friend can be shared with someone who normally wouldn't be part of said communication. When adding potential friends or receiving friend requests, there is no way to tell whether the user is the person they claim to be. These social networks also lack the ability to directly communicate with others who are not on your friends list. Additionally, there is no functionality for parents to monitor their children's online activities. Lastly, many companies that are part of these social networks do not have the ability to share confidential or personal information to employees.

### SUMMARY OF THE INVENTION

One or more embodiments of the present invention provide a method for managing a social network user's profile data items, wherein a user's profile data items are information that describes the user.

One or more embodiments of the present invention provide a method for managing “connections”. A “connection” of a user, in the present application, refers to a person in the system that a user knows closely, such as for example, family, friends, colleagues, classmates, or neighbors, similar to “friends” in current social networks. In at least one embodiment “connections” are managed by placing information or data about the connections into personal social circles, tables, or databases in computer memory, based on the relationships of the connections to the user. The term “circle” will be used in this application, as an abbreviation for a “social circle” with characteristics and/or data that is stored in a computer memory.

One or more embodiments of the present invention provide a method for implementing and managing public social circles. These public social circles may include for example, local/community based social circles (City-County-State-Country), school social circles, work social circles, organization social circles, and events/interests/activities social circles. Potentially, there could be a “public circle” by anything imaginable.

One or more embodiments of the present invention provide methods for connecting and linking related circles. Every circle can include sub-circles, or inner circles, resulting in an unlimited hierarchy of circles.

One or more embodiments of the present invention provide methods for time capsuled events circles, such as birthdays, anniversaries, school graduations, company picnics, an organization's developers annual conferences, sports finals or any event that occurs (re-occurs) on a specific date or within a date range.

One or more embodiments of the present invention provide methods for communicating/sharing with non-connections (i.e. non friends) within public social circles. A “non connection” of a user, in the present application, refers to a person who is not close to a user as that user's personal connections.

One or more embodiments provide a method for customizing the visibility and altering the values for each profile data item for each circle, potentially resulting in a different identity of a user for every circle.

One or more embodiments of the present invention may provide a method for managing user interaction with circle content, such as for example, posts, videos, pictures, recommendations, wish lists, links etc.

One or more embodiments may provide a method for managing and ranking users' profiles indicating level of authenticity.

One or more embodiments may provide a method for creating and managing sub-accounts, and limiting functionalities to such sub-accounts, such as for example, a child account that a parent creates that is only allowed to use family and school circles.

One or more embodiments of the present invention may provide methods for managing public circles (public or private mode) content to be stored outside of the main system (e.g.: hosted within an organization's intranet).

### BRIEF DESCRIPTION OF THE DRAWINGS

FIG. 1 shows a block diagram of an apparatus for use in accordance with an embodiment of the present invention;

FIG. 2 shows a block diagram of a method that a system will use to determine the accessibility of another user's personal circle with the apparatus of FIG. 1, in accordance with an embodiment of the present invention;

FIG. 3 shows a block diagram of another method for a system to determine levels of access for a circle and its inner circles for use with the apparatus of FIG. 1;

FIG. 4 shows a block diagram of a method that illustrates how a user can organize his/her personal connections into various personal circles for use with the apparatus of FIG. 1.

FIG. 5 shows a block diagram of a method of controlling a user's profile to create a unique and different identity for each circle for use with the apparatus of FIG. 1;

FIG. 6 shows a block diagram of some personal circles a typical user could personally have and some public circles the user could be members of;

FIG. 7 shows block diagrams of how a system, in accordance with an embodiment of the present invention, determines how one user will have access to another user's personal connections when the first user is a connection in one more of another user's personal circles;

FIG. 8 shows a block diagram of a method in which a user automatically becomes a member of a public circle, based on data entered on their profile, and how both members and non-members interact with the content stream of that public circle;

FIG. 9 shows a block diagram of a method of a user altering his/her identity with two different circles;

FIG. 10 shows a block diagram of a process of automatically adding a user to various public circles based on information entered into their profile;

FIG. 11 shows a block diagram of a method of how a public circle can store its circle contents outside of a main system within a third party entity system, and how a web view controls access of content from both a main system and a third party entity system; and

FIG. 12 shows a block diagram of a method to validate the authenticity of a user using inputs from users who added the user as personal connections

### DETAILED DESCRIPTION OF THE DRAWINGS

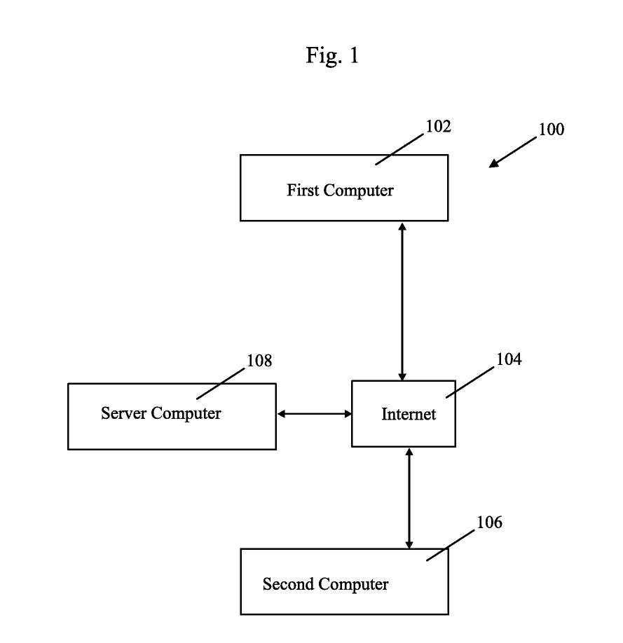

FIG. 1 shows a block diagram of an apparatus 100 for use in accordance with an embodiment of the present invention. The apparatus 100 includes a first computer 102, a second computer 106, and a server computer 108 which are connected by communications links to the internet 104. The communications links may include wired, wireless, computer software links, optical, or any other kind of communications links known.

Each of the first computer 102, the second computer 106, and the server computer 108 may include a computer memory, a computer monitor, a computer interactive device (such as including a computer keyboard, computer mouse, computer touch screen), and a computer processor. Each computer memory of each of 102, 106, and 108, may include computer software, which may be executed and/or implemented by each computer processor of 102, 106, and 108, respectively. Each of the first computer 102, the second computer 106, and the server computer 108, may be any type of computer or computing device, such as a mobile device, personal computer, tablet computer, or any other type of computer or computing device.

The server computer 108, known throughout this document as the “main system” and may include many interacting systems, such as for example, computer servers, computer databases, and other computer components. The main system or the server computer 108 may connect to other systems outside of the main system or the server computer 108, through Application Programming Interfaces (API) to retrieve/send data for use within the main system or the server computer 108, (as in decentralized organizations and individuals circle content).

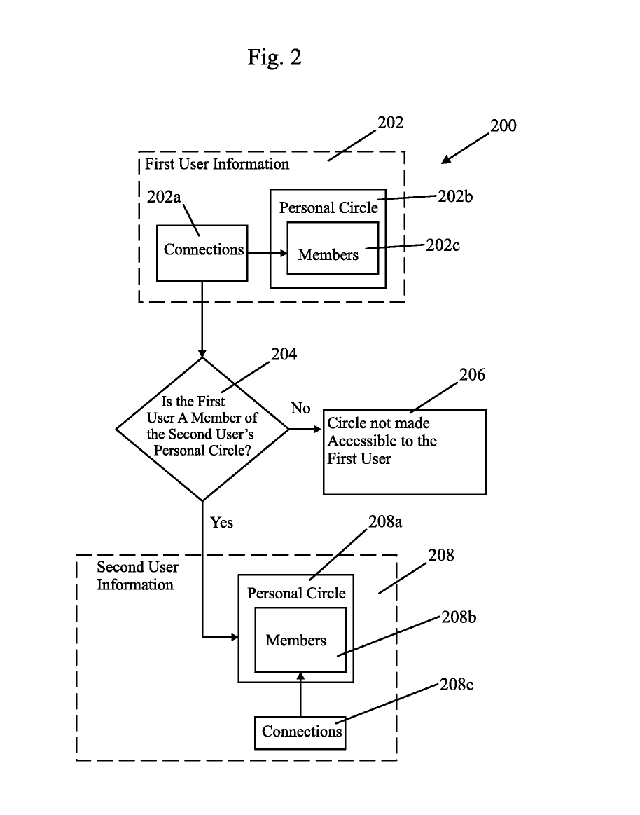

FIG. 2 shows a block diagram 200 of a method for use with the apparatus 100 of FIG. 1. Box 202 represents First User Information and box 208 represents Second User Information. Box 202a illustrates a first user's personal connections, which are other registered users of the Main System that the first User explicitly added as a “friend”. The connections 202a may be stored in computer memory of the server computer 108. For users in the main system or the server computer 108 to interact with these personal connections, the user will have to create personal circles in computer memory of the server computer 108, as shown by box 202b, and place personal connections data into these personal circles, such as members box 202c, in order to communicate or share content (status updates, links, recommendations, pictures etc.) with other members of the particular circle.

In at least one embodiment, the method may include accessing First User Information 202, which may be stored in computer memory of any or all of 102, 106, and 108. In at least one embodiment, a computer processor of the server computer 108 may be programmed by computer software or may implement a computer program stored in a computer memory of server computer 108 to determine if a first user is a member of a second user's personal circle at step 204, shown in FIG. 2. The first user information 202 may be a table of data, and may include connections data 202a and personal circle data 202b. The personal circle data 202b may include members 202c which are a subset of the user's personal connections data 202a. For the second user information 208, 208c represents a collection of all of the second user's personal connections, the second user's personal circle 208a, and a subset of the personal connections as members 208b of the personal circle 208a.

If the server computer 108 determines that the first user is not a member of the second user's personal circle at step 204, then the server computer 108 is programmed to not make the circle accessible on a computer monitor of first computer 102 at step 206. For example, if the first user types in a first user password, then the first user may not be allowed to access the circle 208a and the data associated with the circle 208a.

If the server computer 108, after receiving first user identification and password, determines that the first user is a member of the second user's personal circle 208a at step 204, then the first user may be allowed access to the personal circle 208a of second user.

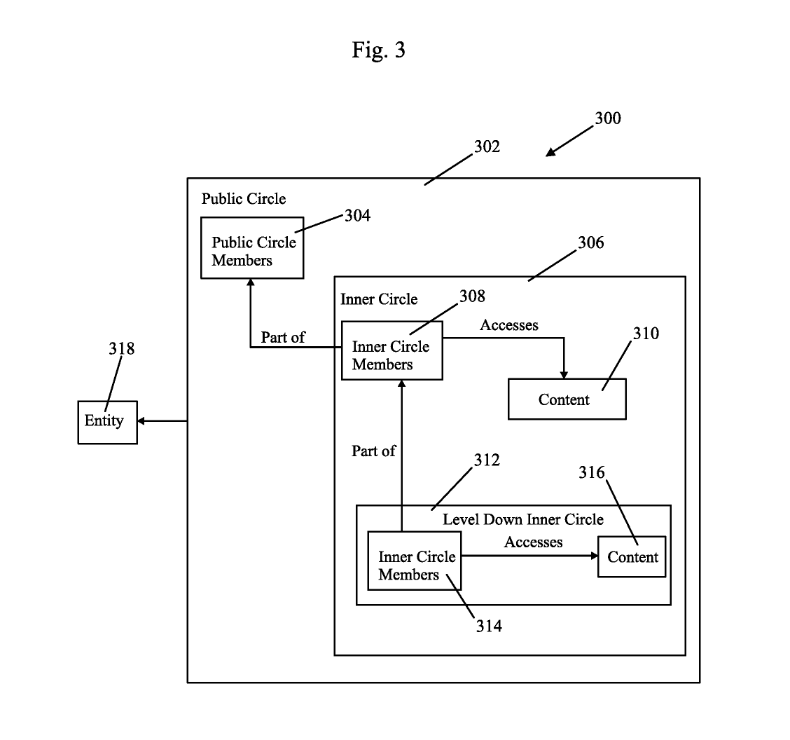

FIG. 3 shows a block diagram 300 of another method for use with the apparatus 100 of FIG. 1. FIG. 3 shows public circle data 302 being provided by an entity 318. The entity 318 may be the server computer 108 or may be some other computer and the public circle data 302 may be provided via the internet 104 or via one or more communications links. Public circles are any circles that are not personal circles. With all circles (personal and public), there may be sub-circles or “Inner Circles”, and all circles include members belonging to that specific circle. Every type of circle (including inner circles) can have “Inner Circles”. This provides a hierarchy of circles. Inner circles provide a more refine members and content structure. All members of inner circles are subset from their immediate parent circle. The public circle data 302 may include public circle members 304 and inner circle data 306, which may be stored in computer memory of the server computer 108. The inner circle 306 is a sub circle of circle 304. Members of the Inner Circle 308 are a subset of members from its immediate parent circle members 304. Members 308 may only access content data 310. Additionally, circle 306 may have an inner circle 312. Circle 312 members are a subset of members of 312 immediate parent circle 306. Only members 314 of circle 312 may have access to the content 316. Furthermore, each public circle may have many settings, that are stored in computer memory of the server computer 108, that will determine whether non-members can access the circle itself, by typing in a non-member password, (as searching the main system), members and/or content. As such, some circles may be hidden or not accessible from all non-members, whereas members must be invited to join, then only these members will have access to the circle's content. Additionally, there could be some public circles that the server computer 108 may be programmed by computer software to potentially allow any registered users of the Main System or the server computer 108, to join and communicate with.

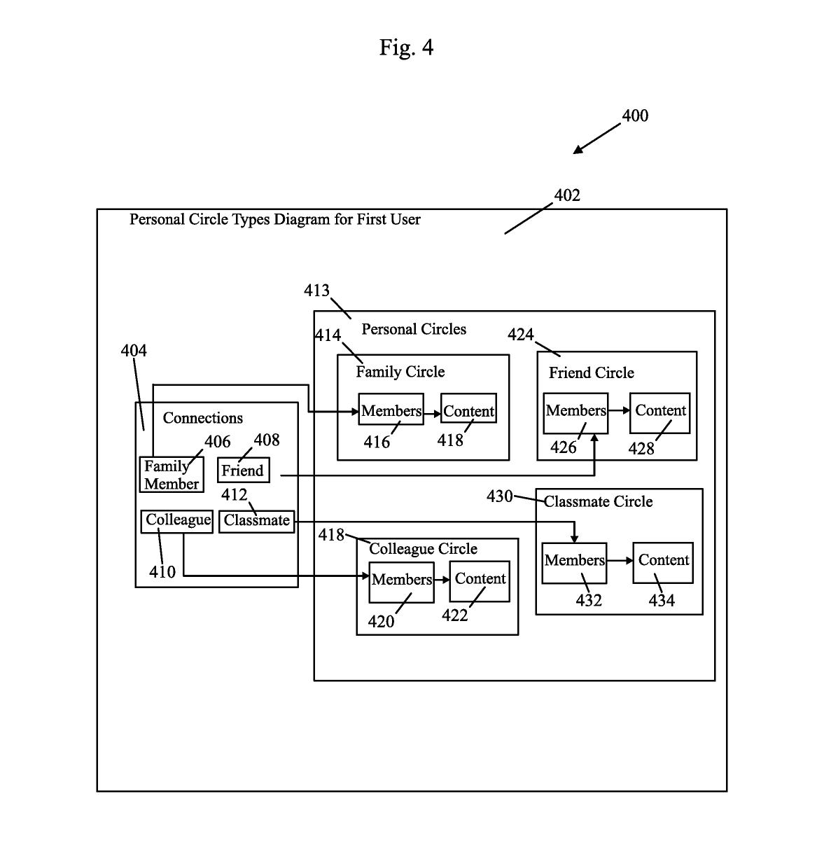

FIG. 4 shows a block diagram 400 for personal circles for a first user 404. In at least one embodiment of the present invention, users must add other users explicitly (such as adding as a “friend”) to their personal connections data stored in computer memory of the computer server 108.

The connections data 404 is one ungrouped list of a distinct list of a user's personal connections, stored in computer memory of the server computer 108. Boxes 406, 408, 410 and 412 provide a “logical” view of the First user's connections. Users must place these connections as members of their personal circles, by entering data into, for example first computer 102, which is then supplied via internet 104 to the server computer 108 and stored in computer memory of the server computer 108, in order to communicate and share content, with other members of a particular circle. As such, for this example, this First user has four personal Circles. The personal circles may be family 414, colleagues 418, friends 424, and classmates 430. Each of circle data 414, 418, 424, and 430 may be a table of data, which is stored in computer memory of the server computer 108. The family circle data 414 may include members 416 from the user's personal connections 404, and will have access to 414's content 418. The friend circle 424 may include members 426 from the user's personal connections 404 and have access to 426's content 428. The classmate circle may include members 432 from the user's personal connections 404, and have access to 432's content 434. The colleague circle 418 may include members 420 from the user's personal connections 404 and have access to 420's content 422. Additionally, a single connection from 404 can belong to zero or more of a personal circle for the first user.

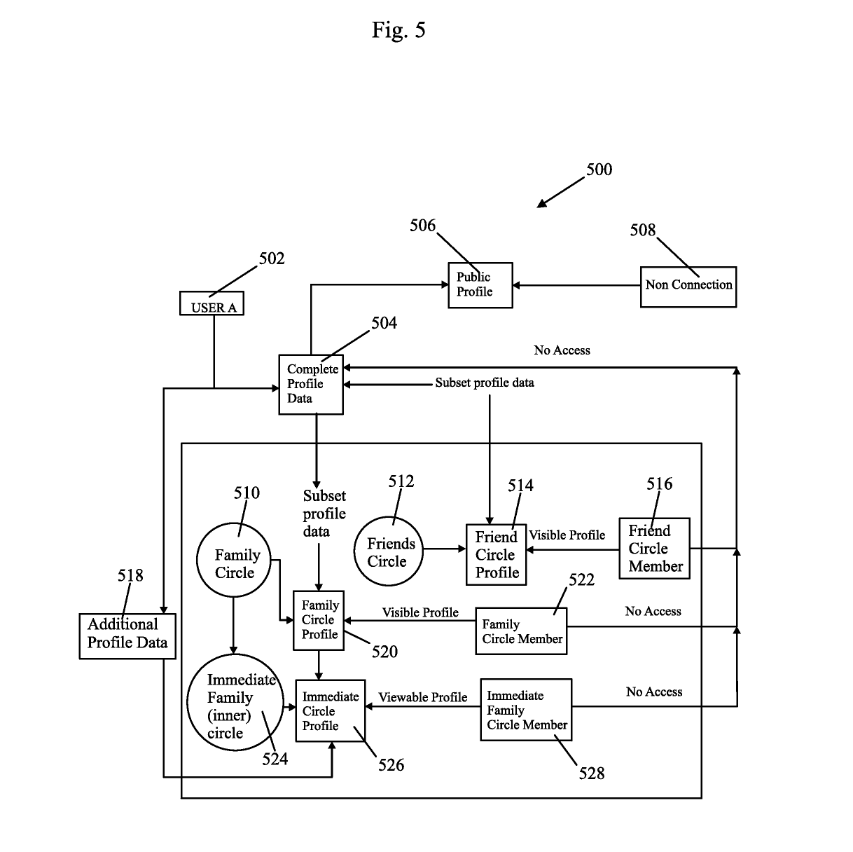

FIG. 5 shows a block diagram 500 of a method for assembling various profile data items from a user's profile to potentially create a different identify for each circle for use with the apparatus 100 of FIG. 1. The block diagram 500 shows user A 502. This user would typically enter a series of information (profile data items) that describes him/her and this information is saved as this user's complete profile data 504, in computer memory of the server computer 108. The user's complete profile data 504 may include the user's name, uploaded images, date of birth, marital status, residencies, schools attended, employment history, interests etc. This user could typically have many personal circles, such as for example circle 510—family circle 524—inner circle derived from 510, 512—friends circle. The User A may have a completely unique identity for each circle. This identity is the chosen and/or altered personal profile data items (from complete profile data 504) for User A, where members of each respective circle would only be able to view for User A. For example, if User B is a member of User A friends circle 512, when user B navigates through the main system, i.e. by use of first computer 102 accessing server computer 108 via internet 104, to view the profile for User A, User B will only see the profile data items that User A wants all members of his Friends Circle 512 to view, such as friend circle profile data 514.

Each accessibility scope of all data items of complete profile data 504 is either private or public. If a data item is private, that information will not be accessible to others unless modified in a derived circle profile. All profile data items that the user chooses initially to be public, is collectively known as the user's public profile 506, which is accessible to all registered users of the system, such as by entering a registered user password, in a first computer 102 and accessing via the internet 104 information from the server computer 108. The server computer 108 will suggest the minimal public profile data items to the user computer 102, for example, via the internet 104, (such as first name, last name, and an uploaded profile image as public, while all others should be private). Public profile 506 is what all non-connections of User A will see if they search for, using the first computer 102, via the internet 104 to access the server computer 108, and find User A.

All circle profiles will derive their scope (hidden or accessible) from their immediate parent's circle, or if a top node circle (no parent) will derive from the public profile (506). The user will have additional options to either use the default public profile, make additional profile data items (from complete profile data 504) accessible, and/or alter any of the profile data items to create a unique identify for each circle.

Item 520, which is the profile for User A's Family Circle, is a subset of the complete Profile Data 504. When any members, such as member 522 of the User A's Family Circle 510 navigates in the main system and tries to view the profile for User A, these members will be limited to only view and/or access what User A made visible or accessible in Family Circle profile 520.

Personal circle immediate Family Circle 524 is an inner personal circle derived from the Family Circle 510 and by default, immediate circle profile 526 for circle 524, will derive all scope (hidden, accessible or altered) profile from Family Circle profile 520. Additionally, User A can add additional data 518 to profile 526. When members, such as member 528 of the immediate Family Circle 524 try to view or access the profile for User A, they will see profile 526.

Similarly, in User A's friends circle 512, a possible different set of profile data items can be the friend circle profile 514 for circle 512, which by default derives from the public profile 506. Additional modifications can be made on profile 514 to create a unique identity for User A within the friends circle 512.

Members of all circles will not have direct access to User A's complete profile data items 504. The only views of User A's sets of circle members have is what is defined by user A in the respective circle profiles.

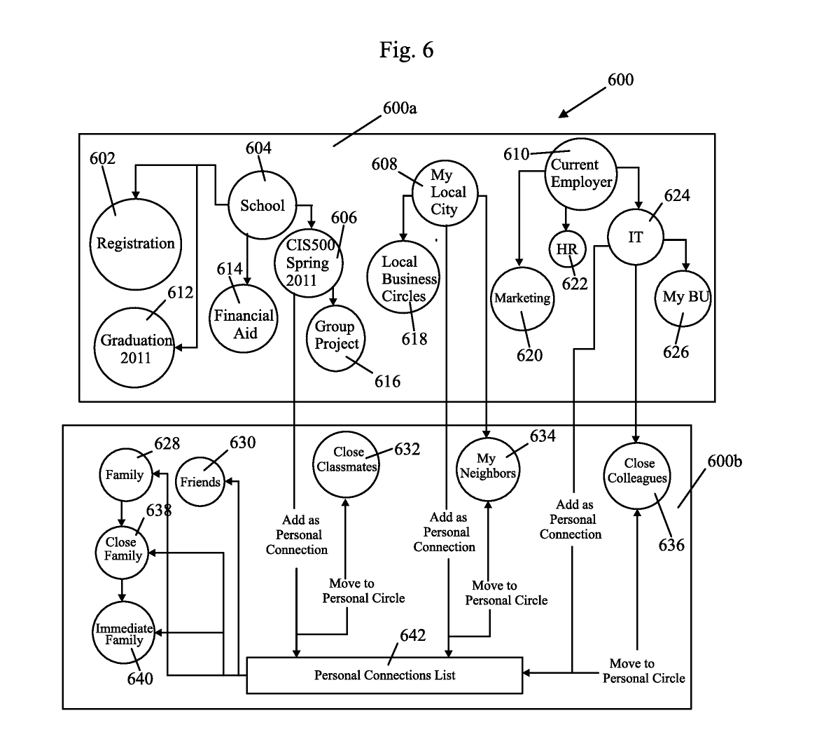

FIG. 6 shows a block diagram 600. The block diagram 600 includes data, which may be stored in computer memory of the server computer 108 of FIG. 1, and may pertain to a specific human being, such as for example “John Smith”. “John Smith” will be allowed to communicate in many public circles (FIG. 6—top block 600a) and his personal circles (FIG. 6—bottom block 600b). The top block or section 600a on FIG. 6 illustrates several public circles, such as for example school public circle 604, My Local City public circle 608, and my Current Employer public circle 610. Every circle may additionally create inner circles to more specialized circles. Inner circles for 604 are Registration 602, Graduation 2011—612, Financial Aid 614, CIS500 Spring 2011—606, and 606's inner circle Group Project 616.

Inner circles for My Local City public circle 608 may include any number of local businesses located or doing business within a specific locality.

Inner circles for my current employer 610 includes marketing 620, HR 622, IT 624, and IT contains an inner circle My Business Unit 626.

Users may typically communicate with members of these public circles without explicitly adding them to their personal connections 642. Communication content will reside within these public circles. As described in FIG. 5 detailed description above, a user will have the option to create a totally unique identity for every circle in the system, including any personal circles, any public circles and any derived inner circles.

The bottom block 600b in FIG. 6 shows a user's personal circles, which includes family personal circle 628, close family inner circle 638 where its members are part of 628, immediate family inner circle 640 where its members are part of 638, friends personal circle 630, close classmates personal inner circle 632 where its members are part of 606 (my current class) public circle, my neighbors personal circle 634 are a subset of the members of my local public circle 608, and close colleagues personal circle 636 for who are members of my current Employer's inner circle 624(IT).

Unlike public circles that may be accessible and viewable and may be available to all users, users' personal circles are held by and belong to a specific user. Other users may be unaware of the composition (members' content, settings etc.) of another user's personal circles. Furthermore, members of personal circles may include personal members of a user's personal connections that the user adds explicitly.

Circles 628, 630, 632, 634 and 636 are top-level personal circles. Circles 632, 634 and 636 may be inner personal circles derived from public circles. Circle 638 is an inner circle of 628, and circle 640 is an inner circle of circle 630.

Graduation 2011 circle 612 and CIS500 Spring 2011 circle 606 are special types of circles known as event circles. Event circles are similar to other circles (personal or public), but are 1) temporal in nature and 2) linked to a specific circle. First, these event circles are for specific events (as in time driven for a specific date or date range)—such as a school Graduation (box 612), or a user's birthday, wedding anniversary, family vacation, a class trip, a company outing etc. Postings to these circles will stop at a specific date/time, while they may be viewable in the system as a form of a time capsule. Second, they are linked to a specific circle, similarly to an inner circle.

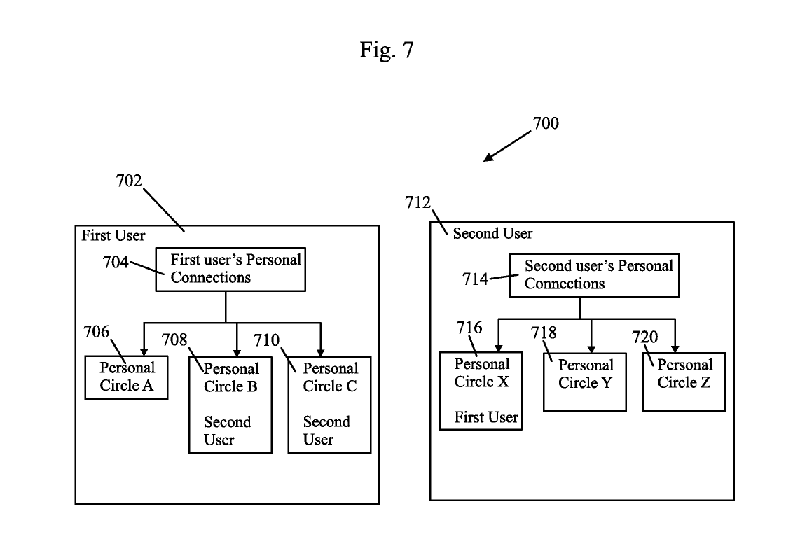

FIG. 7 shows block diagrams of first user information 702 and second user information 712, each of which can be stored in computer memory of the server computer 108. The first user information 702 includes first user personal connections 704, which are linked to or which includes personal circle A 706, personal circle B 708, and personal circle C 710. The second user, whose information is shown in 712, may be part of the personal circle B 708 and the personal circle C 710, so that the second user 712 can access information available to members of those personal circles.

The second user information 712 includes second user personal connections 714, which are linked to or which includes personal circle X 716, personal circle Y 718, and personal circle Z 720. The first user, whose information is shown in 702, may be part of the personal circle X 716 and so that the first user 716 can access information available to members of that personal circle.

The first user does not know the existence of the second user's circles where he is not a member, such as Circle Y and Circle Z. Also, the second user is unaware of the first user's Circle A. additionally; neither user has direct access to each other's personal connections 704 and 714.

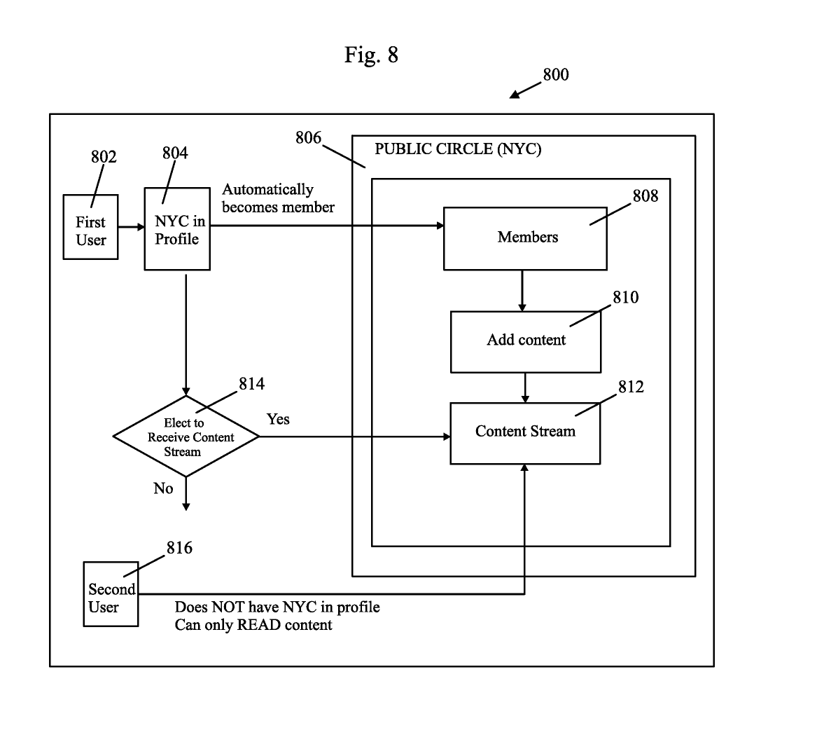

FIG. 8 shows a block diagram 800 of a method in accordance with an embodiment of the present invention. First user data 802 is provided from a computer, such as first computer 102 to the server computer 108. A computer processor of the server computer 108 may examine the data 802 and determines that an NYC (New York City) data indication is in the first user data 802. If that is the case, then the first user may be automatically made a member of the public circle (NYC) 806. This means that the first user having data 802 will be able to access information via the server computer 108 that a member of the public circle (NYC) is allowed to access. The public circle NYC 806 may include members' data 808, which may have a list of members of the circle 806. All members of public circle 808 can post content to the content stream 812. The first user data 802 may indicate if the first user wants to receive a content data stream from a server computer 108 for public circle (NYC) members. Second user data 816 for a second user, which does not have NYC in a profile, may only read content of content stream 812, but cannot post any content to the content stream 812.

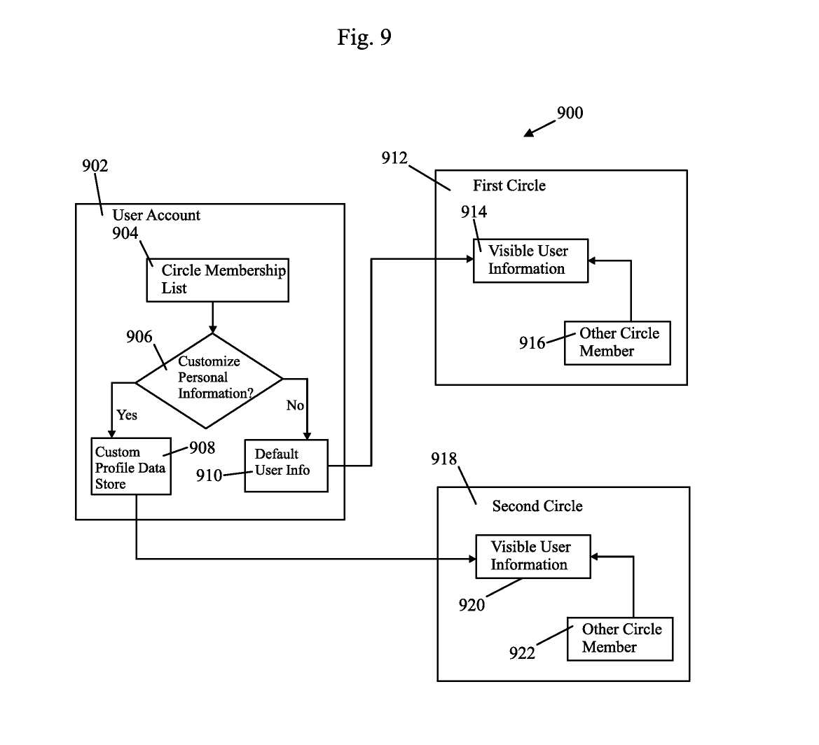

FIG. 9 shows a block diagram 900 of a method in accordance with an embodiment of the present invention. User account information 902, which may be stored in the server computer 108 of FIG. 1, is shown in FIG. 9. The user account information 902 includes a circle membership list 904. The server computer 108 may be programmed to determine at step 906 whether personal information from the circle membership list 904 should be customized at step 908, or not, i.e. default to user information at step 910. If the personal information is customized, it may be stored in computer memory of the server computer 108, and may be provided to a second circle 918. The customized information may be stored in visible user information 920 computer memory of the server computer 108, and may be accessible to other circle members, such as 922. If the personal information is not customized then default user information 910 may be stored in visible user information 914 computer memory of the server computer 108. Circle members, such as member 916, having access to first circle 912 can access visible user information 914.

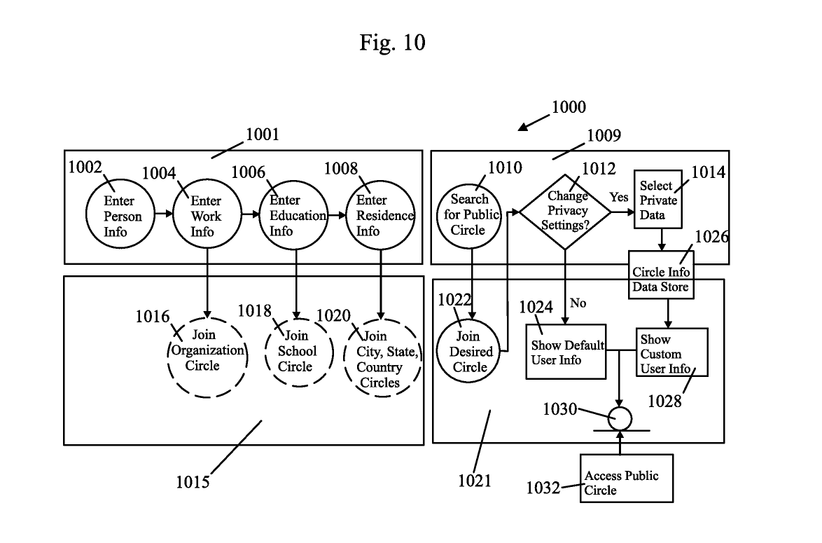

FIG. 10 shows a block diagram 1000 of a method in accordance with an embodiment of the present invention. The block diagram 1000 includes profile owner user registration information and/or method steps 1001. The profile owner user registration information and/or method 1001 includes the step of entering personal information 1002, such as into the first computer 102 which is sent to the server computer 108 via internet 104. The method 1001 further includes entering work information 1004, entering education information 1006, and entering residence information 1008, such as into first computer 102, such as for a first user. This information is also sent by the first computer 102 to the server computer 108 via internet 104.

The block diagram 1000 also includes information and/or method steps 1015. The information and/or method steps 1015 deal with public circles. At step 1016, the work information previously entered at step 1004 is provided to cause the first user to join an organization circle at step 1016. Information regarding the organization circle, including the first user's work information may be stored in computer memory of the server computer 108. At step 1018, the education information previously entered at step 1006 is provided to cause the first user to join a school circle at step 1018. Information regarding the school circle, including the first user's education information may be stored in computer memory of the server computer 108. At step 1020, the residence information previously entered at step 1008 is provided to cause the first user to join city, state, and/or country circles at step 1020. Information regarding city, state, and/or country circles, including the first user's residence information may be stored in computer memory of the server computer 108.

The block diagram 1000 also includes public circle access information and/or method steps 1009 for a profile owner, such as a first user and public circle access, public circle information and/or method steps 1021. At step 1010 any user can search for any public circles, and explicitly join said circle as in step 1022. At that point the user can control several privacy settings as in step 1012. If user does not want to change the privacy settings, the default public profile as in step 1024 will be visible. If the user elects to make any other private profile data items visible as in step 1014, those profile data items will be visible, and will be that circle's custom profile identify for the user as in step 1028. Step 1032 allows public users to access information, which is being shown publicly.

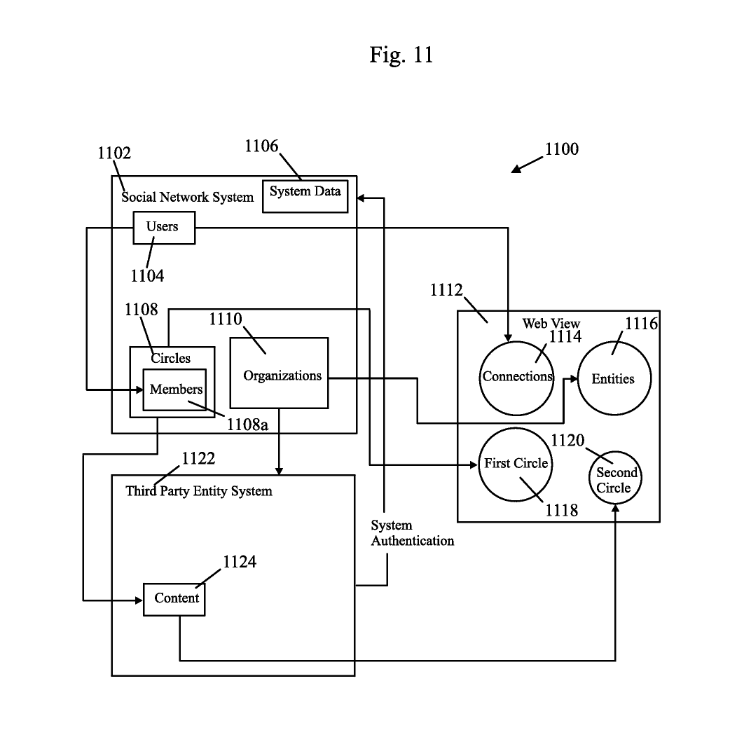

FIG. 11 shows a block diagram 1100 of the architecture of decentralized external systems or third party entity system 1122 interacting with main system or social network system 1102.

The block diagram 1100 includes social network system 1102, third party entity system 1122, and web view user interface 1112. Each of the components 1102, 1122, and 1112 may be a computer having a computer processor, computer memory, computer display, and computer interactive device. The social network system 1102 may include users 1104, which may be a list of users stored in computer memory of social network system 1102. The system 1102 may further include system data 1110 which may include data for system functionality stored in computer memory. The system 1102 may further include social circles data 1108, which may include members' data 1108a, which may be stored in computer memory of system 1102. The system 1102 may include organizations data 1110 which may be stored in computer memory of system 1102.

The web view 1112 may include connections data 1114, entities data 1116, first circle data 1118, and second circle data 1120. The third party entity system 1122 may include content data 1124.

Users data 1104 and system data 1106 concerning data about social circles, such as circles 1118 and 1120 composition and data about the third party entity system 1122 may be stored in computer memory of the social network system or computer 1102. However, typically the communication content of social circles, such as communication content of circles 1118 and 1120, may be stored within the third party entity system 1122 (outside of the main system or social network system 1102). The third party entity system 1122 may include the main system's or social network system's 1102 approved servers and/or databases, and may communicate with the main system or social network system 1102 using Application Programming Interfaces (API) to send and receive data typically via the internet. This data will be presented into the Web View server computer 1112 for users to access via computers via the internet.

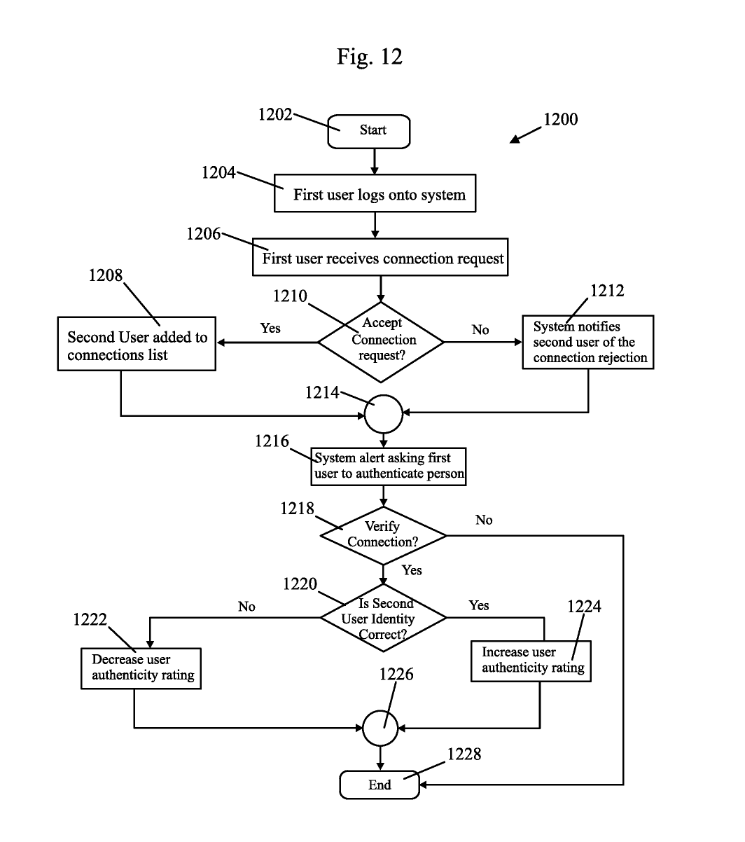

FIG. 12 shows a block diagram 1200 of a flow chart of a method and apparatus in accordance with an embodiment of the present invention. The method and/or apparatus starts at step 1202. At step 1204, a first user, such as by using first computer 102, logs onto a social networking web site or system in accordance with an embodiment of the present invention. The first computer 102 may access a web site provided by the server computer 108 via the internet 104. At step 1206 the first user may receive a connection request at the first computer 102 from the server computer 108, via the internet 104. The connection request may come from a second user. At step 1210, the first user may accept or reject the connection request. If accepted, the second user may be added to a connections list stored in computer memory of the server computer 108 for the first user. If not accepted the system may notify the second user, at for example second computer 106 of the connection rejection, such as by email or other method.

The method continues at step 1214. At step 1216, a system alert may be sent by the server computer 108 to the first user, such as at first computer 102, asking the first user to authenticate the second user that the first user added as a personal connection at step 1218, the server computer 108 determines if the first user has verified the connection (the second user in this example) If yes, then at step 1220, the server computer 108 prompts the first user for whether the second user's identity is correct. If yes, then at step 1224, the second user's authenticity rating is increased in computer memory of the server computer 108. The method then continues at step 1226 and ends at step 1228.

If the connection was not verified at step 1218, then the method ends at step 1228.

If the second user identity was not correct at step 1220, then at step 1222 the user's authenticity rating is decreased, and the method ends at step 1228.

In accordance with at least one embodiment of the present invention, a user needs to register in order to use the social networking system, apparatus, and method. A user may register by using first computer 102 to register or store registration information on server computer 108 via internet 104. Typically after registration, a user can add information that describes the user to a collection data set, known as that particular user's “Profile” data. User A's complete collection of profile data items is shown is step 504. The “Profile” data can be stored in computer memory of the server computer 108. “Profile” data can include data, photos, videos, and other information. A user can explicitly choose the scope (such as public or private) of each profile data item, with the default may be that the user's real full name (first and last), an optional uploaded profile picture, and an optional bio summary as public as in step 506, while all other items are private. In at least one embodiment a user can also make these initial default public items private, such as by clicking on a setting on first computer 102, which is transmitted to the server computer 108 via internet 104. If a user chooses all profile data items to be private, the user would essentially be invisible to the system, all users, search engines and any other systems.

In at least one embodiment, a user may choose to be anonymous within a public circle with an anonymous profile (if public circle permits). In at least one embodiment, the user may supply a setting such as via first computer 102 and internet 104 to the server computer 108, such that all profile data items are not viewable or accessible to all of the user's connections. In at least one embodiment a user has full control to selectively show only specific profile data items that the user wishes to be visible for each connection via the social circles the individual belongs to.

The following are some sample profile data items that may be supplied to describe a user: Note that in at least one embodiment email, username, first name, last name and date of birth may be mandatory and other profile data items may be optional: This collection of information about a user is depicted by FIG. 5-504.

(1) Email

(2) Username

(3) First Name

(4) Last Name

(5) Profile picture

(6) Marital Status

(7) Wedding Anniversary

(8) Religion

(9) Pets

(10) Date of Birth
a. Day
b. Month
c, Year

(11) Residencies (Address and period)—Current and Past
a. Street
b. City
c. State/Providence
d. Zip
e. Country
f. From
g. To

(12) Work (Name, address and period)—Current and Past

(13) School (Name, address and period)—Current and Past

(14) Church (Name, address and period)—Current and Past

(15) Membership Groups (Name, address and period)—Current and Past

(16) Interests (Categorized—Users pick and choose)
a. Books
b. Movies
c. Music
d. Grocery
e. Cars
f. Computers
g. etc.

In accordance with at least one embodiment of the present invention a public profile of a user can be stored in computer memory of a server computer, such as server computer 108. The public profile or public profile data may have data items which can be viewed or accessed via the internet 104 by any user of the social networking method, system, and apparatus of one or more embodiments of the present invention or which may be made public to search engines. In accordance with one or more embodiments of the present invention, anonymous profile data may be stored in computer memory of the server computer 108. The anonymous profile data allows a user to be anonymous in a public social circle, if the public social circle allows it, as determined by computer software stored in computer memory of the server computer 108. Anonymous profile data may be helpful when posting in a public social circle, and the user does not want to associate themselves explicitly to the social circle, for example such as a cancer patient posting general questions at a pharmaceutical company's brand public social circle.

In accordance with one or more embodiments of the present invention, there may be two types of users or connections, that a user can communicate/share content with via the internet 104, from for example the first computer 102 to the second computer 106, such as by use of server computer 108. The first type of users is personal connections, which may be identified and/or stored in computer memory of the server computer 108 on a personal connections list 642. The personal connections list typically may include individual human beings that a user knows very well, such as friends and family. The second type of users may be public connections that may be people from public social circles that are not close enough to be personal connections (for example as in members of public circles 602, 604, 606, 608, 610, 612, 614, 616, 618, 620, 622, 624, and 626 shown in FIG. 6.

Personal connections may include a connection that a user adds (such as by adding data to the server computer 108) explicitly FIG. 6 lower section 600b shows a typical list of personal circles for a user. Users can browse public social circles, such as public circles shown in upper section 600a of FIG. 6, using the first computer 102 via internet 104 and through the server computer 108, to browse through data concerning public social circles, stored in computer memory, to search for connections within the social networking system on server computer 108, to accept an invitation and then add these connections to his or her own personal circles. For example, a user may add connections from a public circle, step 606, to their personal connections, step 642, which in turn adds the connection to the user's personal circle as in step 632, which may be stored in computer memory of server computer 108. A user can browse the internet, such as by using first computer 102, and search for users in local public circles (as in step 608), and add them to their personal connections (step 642), which the user can further place in personal circles—step 634, Similar scenarios can occur from any public circles (step 624 or step 642 to step 636) When adding a connection, a user can choose to place the connection into a specific personal social circle (such as one of steps 632, 634 and 636) in computer memory in server computer 108, in order to communicate with a person in the specific personal social circle.

Users can create notes, private or public, about any of his/her connections, which are stored in computer memory of the server computer 108. In at least one embodiment, private notes are only visible, via a computer, such as first computer 102, via the internet, and from the server computer 108, by use of a user password, to the user who added the note, while public notes may be visible to other connections.

In at least one embodiment a user can browse, using for example first computer 102 via the internet and view allowable profile data and content, provided by the server computer 108, for all of his connections as illustrated in FIG. 5. Members of User A's personal circles do not have direct access to User A's complete profile, such as via their member passwords. Members 522 of personal circle 512 (which may be a friend's social circle) may not have access to User A's complete Profile data, step 504. Members of Family Circle 510 may not be allowed direct access to the Complete Profile Data, at step 512, by the server computer 108. Also members of 524 may not be allowed direct access to 504 by the server computer 108. The server computer 108 may be programmed by computer software stored in computer memory of the server computer 108 to provide appropriate access to appropriate social circles as desired by.

In at least one embodiment, users cannot browse other users' connections directly, such as by using first computer 102, via internet 104, and via server computer 108. For example, when a user (User A) browses, using first computer 102, another user's (User B) “connections”, stored on computer memory of server computer 108, he/she (User A) may only be allowed to view the connections who are members of the personal circles that he/she (User A) is a member of within that user's (User B) personal circles. What User A is allowed to access may be determined by a computer program executed on the server computer 108 and stored in computer memory of the server computer 108.

The sever computer 108 may be programmed by a computer program so that all other users are not visible or cannot be browsed by User A, in this example. In FIG. 7, the First User 702 does not have access to the second user's personal connections 714, even though the First User 702 is a member of one or more of the second user's personal circles, such as one or more of personal circles 716, 718, and 720. The first user 702 may only be allowed access, by the server computer 108, to the members of the second user's personal circles he/she is a member of, such as in this example, personal circle 716. Similarly, the second user 712 may not be allowed direct access, by the server computer 108, such as via the internet 104, to the First User's Personal Connections 704. But the second user 712 may be allowed access by the server computer 108, as determined by a computer program of the server computer 108, to the personal circles of the first user 702, of which he/she is a member of, such as personal circles 708, and 710, in this case. Furthermore, the server computer 108 may not permit the second user 712 to gain access, by using a second user password, to the personal circle A. Similarly, the server computer 108 may be programmed by a computer program to not allow the first user 702 to gain access the social circles data 718 and 720.

In at least one embodiment, public connections-by-associations, for example members of public circles 602-626, are users from public circles (such as public social circles regarding school, work, local etc.), that a user wishes to communicate/share information with over the internet 104, without adding them as a personal connection to computer memory in the server computer 108. Communication, which includes sharing of content, may occur in any public circles that a user is a member of as these circles are illustrated in FIG. 6 upper section 600a. Each circle of 602-626 in the upper section 600a depicts a public circle.

A social circle is a logical container in computer memory of the server computer 108, or other computer memory, that includes one or more users who share a common relationship or interest. Users who are members of the same social circle, in at least one embodiment, share content and communicate only within a specific social circle. All communications (posts, links, pictures, videos etc.) belongs to a specific social circle where they were posted. In at least one embodiment, all social circles typically inherit a user's public profile by default. FIG. 5 illustrates how profile data items can be customized for every circle. Step 504 is User A 402 of FIG. 4, complete profile data and the computer server 108 may not allow direct access to the complete profile data of 402. A user can explicitly choose any additional profile data items (that's non-public) that should be accessible by members of a specific circle. User A has a personal circle—Family Circle 510, shown in FIG. 5, which the user A identifying this circle 520 is a subset of the user's complete profile data 504. Members of family personal circle 510, such as family circle member 522, in at least one embodiment, will only be allowed access, by server computer 108, to the user's family circle profile data 520 and will not have access to the user complete profile data 504, as determined by programming of the server computer 108. Immediate family (inner) circle 524 may be a more specialized personal circle of family circle 510, as it will inherit all of the profile data items scope from family circle profile data 520. Additional profile data items 518 may be added, made accessible, or altered) to create immediate circle profile data 526, which may differ from profile data 520. Every social circle (personal and public) can be further defined this way

For example, my immediate family circle may be allowed to view all profile data stored in computer memory of the server computer 108. However, members of my cousins' family circle may not be allowed to view all or most profile data. As other examples, members of a school social circle may only be allowed to view or access school and high-level data etc. (most personal data not visible). The limitations on viewing or accessing may be stored in computer memory of server computer 108. Members of a work social circle may only be allowed to view or access work and high-level data etc. (most personal data not visible). Members of a local social circle may only be allowed to access public profile data. Members of a neighbors' circle may only have slightly more than local circle viewable.

In at least one embodiment the server computer 108 may be programmed so that a user, using first user computer 102 via internet 104, can customize any profile data item for every social circle. Each social circle can have a possible different version of the user's profile data, which may be stored in computer memory of the server computer 108, for each social circle. For example for an immediate social circle, a first user's name may be “Daddy”, while for a cousin's social circle, it may be “Uncle B”, while for a school social circle it may be “Prof B”. FIG. 9 illustrates this algorithm. For any circle, a user may use an existing profile data item or customize it. If the user decides to leave a default profile data item that was entered into their complete profile data 504, members of a circle 912 will have access only to the default user info 910. Alternately the user may customize any profile data item from the complete profile data 504 which will be accessible to members of the circle (as second circle 918 in FIG. 9.)

In at least one embodiment there may be four categories of social circles:
a. Personal Circles—these are circles that are created by a specific user for personal use (individual accounts), such as circles 628-640 shown in FIG. 6. These belong to a specific user and are not visible by any other user. Personal circles are private by default and cannot be changed.
b. Public Circles—These are circles that organizations or the system, such as server computer 108, create and are focused towards the public's interests. Users could automatically become members of public circles based on information from their profile data. For example, circles 602-626 in FIG. 6 may be public circles. These are not specific to an individual user. They are open to the general public. However, the owner can limit visibility to the public by setting the circle to private.
c. Inner Circle—A sub-circle that is created under any other circle (personal, public or inner). Examples of public inner circles are 602, 606 612, 614, 616, 618, 620, 622, 624, and 626. Public Inner circle 616 is derived from public circle 606, which derives from public circles 604 and 616, which derives from public circle 624, which derives from public circle 610. Personal circle 638 derives from personal circle 628, and personal circle 640 derives from personal circle 638. Personal circle 632 derived from public circle 606. Personal circle 634 derives from public circle 608. Personal circle 636 derives from public circle 624.
d. Event Circle—A “temporary” circle that is driven by a specific event. For example public circle 612 is driven by or relates to graduation 2011 and public circle 606 is driven by or relates to CIS 500 Spring 2011 (CIS—Computer Information Systems). Since public circle 616 is an inner circle of an event circle 606, it will be treated as an event circle as well. Event circles are a special type of inner circle, which is temporal. Event circles can be public or personal.

In at least one embodiment, the server computer 108 may be programmed by computer software, stored in computer memory of the server computer 108, to automatically create two default personal social circles for each user, which may be (1) Family, such as circle 628 and (2) Friends, such as circle 630. Data concerning the social circles may be stored in computer memory of the server computer 108. In at least one embodiment, the members of personal social circles may only include a user's connections that he/she explicitly adds as a connection. All members of a user's personal circles, such as personal circles 628, 630, 632, 634, 636, and 638 are organized from the user's Personal Connections List 642. A single connection (or person), in at least one embodiment, can belong to one or more of an individual's personal circles. FIG. 7 shows that the second user is a member of two different personal circles, personal circle 708 and personal circle 710, for the first user. Furthermore, in at least one embodiment, the first user will only be listed in the first user's personal connections 704 once, regardless of how many of the first user's personal circles that the second user belongs to. Personal circles belong only to a specific user who created the personal circle, and other users are unaware of the circles existence. FIG. 6 bottom section 600b illustrates a typical user's personal circles. All other users may have similar personal circles of their own. Other users may have direct access to the composition of another user's personal circles. Furthermore, the server computer 108 typically is programmed so that other users, using other user passwords, for example, cannot search for another user's personal circles. The server computer 108 is programmed so that a member of a personal circle can request, via a computer, such as first computer 102 and via internet 104, to add the entire circle to his/her connections, on computer memory of the server computer 108. A user can provide a descriptive name and customize each of his/her personal circles, in at least one embodiment, by entering information into a computer interactive device of first computer 102, which is supplied via the internet 104 to the server computer 108. Each of the personal circles in FIG. 6 bottom section 600b can be customized for the owner/user, including but not limited to a customized name of the personal circle.

In at least one embodiment, public circles are created and managed by the system such as implemented by the server computer 108, individuals, or organizations via computers such as first computer 102 and second computer 106 via internet 104, to share content to the public via the internet 104 to other computers. There may be several major categories of public circles, such as (a) Local city circles—residencies (FIG. 6—circle 608), (b) Work circles—employers (FIG. 6—circle 610), (c) School circles—school (FIG. 6—circle 604), (d) special Interest circles, (e) special groups circles, (f) any other circles.

In at least one embodiment, users are automatically added by server computer 108 as programmed by computer software, as members of these public circles, as indicated in computer memory of the server computer 108, based on data from the users' profiles. FIG. 10 illustrates the flow of how users are added automatically to public circles. As a user completes their personal profile, such as on a first user computer 102 at step 1002 of FIG. 10, when the user enters any employment records at step 1004, the system, such as implemented by server computer 108 executing computer software, will automatically add the user to each company's public circles. If a public circle for a particular employer does not exist, a new public circle of said employer may be created by the system, by server computer 108. When the user enters schools attended at step 1006 in the first computer 102, the user will automatically be added to each school's public circle, by the server computer 108, into computer memory of the server computer 108. If a public circle does not exist, a new public circle of said school may be created by the system running on the server computer 108. When the user adds any residency (past or present) at step 1008 into the first computer 102, the system running on the server computer 108, may be programmed to automatically add the user to local public circles at step 1020 relevant for each address (such as, for example, city, state, region, country etc.)

In at least one embodiment, users of the social networking system implemented by computer server 108, may search/browse all accessible members within most public circles, using, for example first computer 102, via internet 104. The computer server 108 is programmed by computer software in at least one embodiment, to allow system users to add members from these public circles to their personal circles such as personal circles 606-632, personal circles 608 to 634, and personal circles 624 to 636. Members within a public social circle will have access to only the “selected” visible profile data for a user, while non-members will have access to a user's public profile data, in one embodiment. Users may add any public circle as a favorite, by using first computer 102, and internet browser computer program running on first computer 102, whether they are a member or not—the user may receive that circle's content stream (contents shared by members of the public circle).

Users can recommend a public circle to any connection, by the internet 104, where the recipient can either save the public circle as a favorite, or share the recommendation to his/her connections (circles).

The server computer 108 may be programmed to provide a public circle for a specific time period (school graduation ceremonies, TV annual awards ceremonies, sports competitions etc.), such that the public circle is temporary. The term “temporary” means that posting contents to the circle has a definitive end date. An example would be for the Super bowl or World Series, where all users share content that is visible to all users during the time leading up to the big game.

In at least one embodiment, the server computer 108 allows all content and members to be accessible by the members of a particular circle for a public circle.

The administrator of a public circle can add any number of inner circles under any public circles (or other inner circles), and assign a user(s) to manage it. This builds a hierarchy of circles with each inner circle including members belonging to the immediate parent circle. In FIG. 6, circle 604 is a public school circle. This public circle 604 includes inner circles 602—registration, 614—Financial Aid, 612—Graduation 2011, and 606—CIS500 Spring 2011. Additionally each of these inner circles can have inner circles, as circle 606, which has an inner circle 616. All of circle 616 members are members of circle 606, and all of circle 606 members are members of circle 604.

Inner circles may have two modes (a) public mode—circles are visible, searchable by the public, but may or may not show content or connections (members can request to join or be invited to join; and (b) private mode—circle is hidden, i.e. not accessible by a password from a user whose access is being prevented, from all who are outside of the circle (members are invited). FIG. 6—circle 604 is a public circle that may be accessible, by use of a registered user password, by any registered user of the system. The server computer 108 may request a password, and if the user provides an acceptable registered password, the server computer 108 may be programmed to permit access to public circle 604. However, public circle 604 and 606's inner circle 616 may be private. In other words, settings may be in place so members of these circles may be invited to join the circles, and only members may have access to data about the members and other data content within the particular circle. Public circle 606 is a good example of a public circle with public mode, which users can search for the circle and request to join, while public circle 616 is in a private mode. Generally public circles in the present application, in at least one embodiment, refer to non-personal circles. Public circles can be open to the world as “public” or “private” for members only, for example, my current class. It is a public circle because it is not owned by an individual (not personal), but the scope of this public circle is “private” because only members of the “class” have access to it and are not searchable from outside of its parent circle 606.

Users can search for and possibly join public mode circles. Settings stored in the server computer 108 regulate whether connections in these circles are viewable or accessible by non-members. Settings stored in the server computer 108 may regulate whether content in these circles are viewable by non-members.

For a private circle, the server computer 108 may be programmed so that these circles are not searchable, viewable, or accessible by non-members (as for circle 616, which is private and only members have access to members list and content). These private inner circles may be searchable from the immediate parent; for example, members of circle 606 may see the existence of circle 616. In at least one embodiment, a user must be invited to join these private mode circles. For example, for a private class circle—the professor (or administrator) may invite all students currently enrolled in his current class, via for example email supplied over internet 104, accessible by computers, such as first computer 102.

In at least one embodiment, a company may choose to add a business unit private circle, and invite colleagues to join, then only these colleagues who are members are aware of the existence of the private social circle, members, and content. FIG. 6—Step 610 illustrates a public circle for an organization, which has several inner circles; public circle 620 Marketing, public circle 622—HR (“human resources”), public circle 624 IT (“information technology”). Public circle IT 624 has an inner circle My BU 626. My BU—My business Unit 626 may be a private circle that is not searchable, and all members and content may be categorized as private to that circle by the server computer 108.

Inner social circles can be created using first computer 102 by supplying information to server computer 108 via internet 104. The owner of a circle can create inner circles (or sub circles) for any circles (public, personal, private) to further refine and to control profile data and members. The server computer 108 is programmed to allow a user, via first computer 102 and via internet 104 to create inner personal circles under any of his/her personal circles. A user can create inner personal circles under any public circles that they belong to by adding the members from a public circle, as a personal connection. For example, referring to FIG. 6—a user adds members from public circles 606 to his/her personal connections and created a personal inner circle 632. Similarly personal inner circle 634 is a user's personal inner circle derived from public circle 608 and personal circle 636 is a user's personal inner circle derived from public circle 624. Inner circle members are a subset of members of its immediate parent circle. Inner circles members inherit the scope of the immediate parent's profile data items scope (accessibility or visibility). Inner circles can include additional visibility and/or accessibility of other profile data items. The server computer 108 is programmed to allow users via first computer 102 via internet 104 to customize any of these additional profile data items.

Event circles are social circles that are used to manage a specific event or recurring events. In at least one embodiment, the event can be a specific time period, specific date, multiple dates, and recurring. Event circles are temporary, as postings to these circles are within a predefined period/date. Event circle contents will remain for read-only after posting period ends. This is like creating a time capsule of a certain event, such as for example, a school graduation, a sports competition, a TV awards ceremony, a wedding, a birthday party, etc. FIG. 6 illustrates two event circles 612 and 606 that are inner circles of the schools public circle 604. Public event circle 612 is for a specific event—graduation 2011. All members of the school public circle may have access to this event circle and post/share relevant content. After the event concludes, the system may prevent further postings. Similarly event circle 606 is for a specific time for a specific course—CIS500 Spring 2011. Activity in this circle may be directed by a specific time frame as in a semester's range.

Various possible data items can be posted to a specific social circle, such as including but not limited to (a) News/status update—these are short messages, (b) Photo—an uploaded picture, (c) Video—an uploaded video, (d) Photo Album—an updated photo album (collection of pictures) (e) Bookmark—a reference to a URL (bookmark). (1) Any user can create a bookmark list for a specific circle, (2) User can add bookmarks (URL to any source) manually, (3) User can add a note to a bookmark, (4) User can post a bookmark to any circles, (5) User can save a posted bookmark to his list, (6) Circles will aggregate bookmarks, (7) Location check-in—checking in to an existing public circle, (8) Recommendation—a reference to an existence circle or anything else (a) circles may aggregate members recommendations (b) Recommendation can be i) A text note, ii) A reference to a specific circle, iii) A URL to an online reference (9) A wish-list—a reference to a product or service of interest (from anywhere—Local or Web) a) Any user can create a wish-list for a specific circle b) Circles will aggregate members wish-list, c) Can be attached to a circle, d) Items can be added to the wish-list from anywhere for anything, (could be text notes or web links).

In at least one embodiment, a circle page may include the circle's stream (which may be members' live posts), which may be provided by the computer server 108 to computers accessing the circle, such as for example first computer 102 via the internet 104. A list of all members may be browsable/searchable, so that a user knows exactly who can see what they post/share. A social circle page may include the user's profile data items that are shared (visible) in that circle, so that a user can see exactly what profile data items are shared/visible in that circle. A circle page may include a list of all users who have viewed a user's profile and/or specific content that was shared in the circle. A circle page may include a rollup of all members' “shareable” saved content, such as (a) recommendations, (b) bookmarks, (c) pictures, (d) wish-lists, (e) circles. This rollup creates a highly cohesive influential infrastructure, where a user is most likely to use a service or product based on friends and family's influence. A circle page may be saved in computer memory of the server computer 108. A circle page may include links to visible inner circles, for example, in a personal circle; a user would see all of his personal inner circles under this specific circle. In a public circle, a user would see all of the public inner circles under this specific circle. This provides a very intuitive method to navigate through the hierarchy of circles, of all inherited circles, all surrounding circles and all related circles.

A circle stream may contain all contents that members post within a circle. Users may select via computer 102 via internet 104 and server computer 108, which circles streams they would like to view/hide (the default may be to view/hide all). The users may select via computer 102, internet 104, and server computer 108, what content type they would like to view (default all). Any circle stream can be hidden (not deleted), temporarily stop receiving feeds. In at least one embodiment, by default, only members of a circle (personal, public, inner, etc.) can post content to a circle. Public circles can regulate who can post to their circles (members and/or non-members).

In at least one embodiment there will be a local stream for every city in the system provided by the server computer 108 (potentially for every city in the world). In at least one embodiment, the server computer 108 only allows members of these local city circles to post content. Any registered users of the social networking system provided by server computer 108, can view any local streams even if they are not a member of that local circle. Organizations will become part of the local circles based on their address from their profile, and as such would be closely related (or become a closely related circle) to the local circle. An example could be a local pizza business creating a profile for a location in NYC. Users who view the local public circle NYC will be able to search for and find the local business circle.

In at least one embodiment, the server computer 108 may provide school/organization/interest/group streams via the internet 104. Schools, organizations, special interest groups, etc. can create public and/or inner circles. Circle administrators can set who can post and who can view content.

In at least one embodiment, various content stream actions can be performed. For example, “Save As Favorite”. Users can save any content from any stream as a personal favorite by using server computer 108, which is programmed to perform this function when prompted by a computer, such as 102, via the internet 104. Each shared data can be either private or shared within circle. In at least one embodiment, only members of the circle may view the user “shared” saved favorites of the specified content. For example, if a user adds a family connection favorite video, only members of that family circle are able to view this favorite (assuming the user wants to share it with the circle).

In another embodiment a share content stream action can be performed in accordance with computer software of the server computer 108. Users can share (repost) any posts to any circles if the original user who posts it allows it. For example: a family connection posted a picture; another user within that circle can repost that photo to his own family circle (assuming the original user authorizes the photo as shareable).

In another embodiment a comment stream action can be performed in accordance with computer software of the server computer 108. Comments can be added to any post within a stream. There may be two ways to comment on a post, such as like or dislike. When a user likes a post, they can add a positive comment. When a user dislikes a post, the can add a non-positive comment.

Additionally users can comment on another user's comment, building a hierarchy of comments. This maintains a better structure for the feedback for any given shared content.

In another embodiment, the computer server 108 may be programmed to provide a connection ranking system. The computer server 108 may calculate a numerical value for each user's “authenticity”. When users add a connection to their personal circles, the user would rank the connection with a numerical value. This method may include the computer server 108 which may be programmed by computer software to use these users' ranks, and other variables to calculate a “user rank” for the connection.

In at least one embodiment, by default all content is stored within the main system, such as in computer memory of the server computer 108, under two main application infrastructures: (a) Profile system—this is the system for all profile data, circles structure, etc. and (2) Content System—this is the system that contains all of the posts users share.

Users can choose to safe guard all of their content and as such content can be stored at a user's location of choice (outside of the main system). Companies can choose to host their content in house, securing confidential information. In at least one embodiment, all users, circles' structure and profile information would reside in the main system, such as in computer memory of the server computer 108. This would involve the organization running a system approved application and database, which will communicate between the main system's “Profile System” and the company's “Content System”.

Users can create sub-accounts, on the server computer 108, which will allow a user to manage, limit and monitor these sub-accounts. A user may view these sub-account streams under their own account. Each sub-account will typically have their own login credentials, but are controlled by the user who created them. Sub-accounts can be transferred (or broken out) to full account when appropriate or allowed (e.g.: age restriction). Parents can add sub-accounts for children, such as a child less than thirteen years of age. Sub-accounts for children under thirteen years of age are invisible in all public circles and cannot be altered. In addition, content may be filtered for “age appropriateness” before reaching the child. The owner of the sub-account (parent) would have full access from their account, to view all communication from the sub-accounts.

Sub-Accounts, in at least one embodiment, allow a user to control multiple accounts under his/her main account. For example, a parent may create a sub-account for their children and set permissions for their accounts. Primary accounts can see all content for each of their sub-accounts. Another example is a marketing company may have a primary account, and then sub-accounts for marketing employees.

In at least one embodiment of the present invention, when a user logs in with a valid User-ID (user identification) and password, using for example first computer 102, he/she will see, such as on a computer display of the first computer 102 and have immediate access to, all of his/her personal circles and all of the public circles that he/she is a member of. This information would be provided typically through a web site by server computer 108 via internet 104.

The user may add information in his profile, such as by entering data using a computer interactive device, such as a computer keyboard or computer mouse, of first computer 102, and this information may be sent via the internet 104 to the server computer 108. The server computer 108 may be programmed by computer software to analyze the information added by the user to his profile. For example, if information added to the profile deals with the user's work or employment, the server computer 108 may determine this and may be programmed to automatically add the user to “public” social circles, which deal with this type of work or employment. The user may be added to a “public” social circle by adding data to computer memory of the server computer 108.

The server computer 108 may be programmed to allow a search of the web site or system, such as by using an interactive device of first computer 102, via internet 104, to find public circles that a user may be interested in. If he searches the system, and finds any other public circles that he's interested in, he may join or save these to his favorites, in computer memory of the server computer 108. Additionally, there are many different ways a user can join public circles.

Being a member of a public circle or saving a public circle as a favorite, when the user logs into the system, he will, in at least one embodiment, have access to all of these circles. This typically includes public circles that are private (user will be invited to join, by a moderator or member of the circle). In at least one embodiment, after a user has logged in to the web site, typically with a user identification and password, there may be no further need to enter a password. However, passwords (not login password) could be used to join private circles.

In at least one embodiment, personal circles are different. One user cannot see or have access to another user's personal circles. Personal circles are “personal” to the user who owns it. The system, such as implemented by server computer 108 executing computer software stored in its computer memory, in at least one embodiment, will provide mechanisms for members of a personal circle to view other members and content indirectly which may seem like they have access to another users' personal circle, but they do not. Typically in at least one embodiment, no users will have direct access to another user's personal circles.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

We claim:

1. An apparatus comprising:
a server computer including a server computer processor and a server computer memory;
wherein the server computer is programmed by computer software to provide an internet web site;
wherein a first user can log on to the internet web site via a first computer and the internet;
wherein the server computer is programmed to cause the internet web site to display information on a computer display of the first computer concerning a plurality of social circles for the first user, after the first user has logged on to the internet web site.

2. The apparatus of claim 1 wherein
the information concerning the plurality of social circles for the first user is stored in the server computer memory.

3. The apparatus of claim 1 wherein
the plurality of social circles includes one or more public social circles and one or more personal social circles;
wherein the server computer is programmed by computer software to provide information concerning the one or more public social circles to any user who is a member of the internet web site; and
wherein the server computer is programmed by computer software to provide information concerning the one or more personal social circles only to users who are both members of the internet web site and members of the one or more personal social circles.

4. The apparatus of claim 1 wherein
the server computer is programmed to store in server computer memory a different set of profile information for the first user for each of the plurality of social circles.

5. The apparatus of claim 3 wherein
the server computer is programmed to maintain a list of members of each of the plurality of personal social circles in server computer memory; and
the server computer is programmed to permit access to information for a particular social circle of the one or more social circles, only to users who are on the list of members, and who log on to the internet web site.

6. The apparatus of claim 1 wherein
the plurality of social circles includes one or more parent circles, each of which include one or more inner circles;
wherein the server computer is programmed to permit a first set of members to access information concerning the one or more parent circles and the one or more inner circles; and
wherein the server computer is programmed to permit a second set of members to access information concerning the one or more parent circles, but not the one or more inner circles.

7. The apparatus of claim 1 wherein
the plurality of social circles include one or more event circles concerning one or more events; and
wherein the server computer is programmed to provide information concerning each of the one or more event circles for only a range of time of times of occurrence of the one or more events.

8. A method comprising:
providing an internet web site from a server computer;
causing the internet web site to display information on a computer display of a first computer concerning a plurality of social circles for a first user, after the first user has logged on to the internet web site.

9. The method of claim 8 further comprising
storing the information concerning the plurality of social circles for the first user in server computer memory of the server computer.

10. The method of claim 8 wherein
the plurality of social circles includes one or more public social circles and one or more personal social circles;
and further comprising providing information concerning the one or more public social circles from the server computer via the internet to a first computer in response to identification information provided at the first computer by any user who is a member of the internet web site; and
allowing access to information concerning the one or more personal social circles from the server computer via the internet to the first computer only in response to identification information provided at the first computer by a user who is both a member of the internet web site and a member of the one or more personal social circles.

11. The method of claim 8 further comprising
storing in server computer memory of the server computer a different set of profile information for the first user for each of the plurality of social circles.

12. The method of claim 10 further comprising
maintaining a list of members of each of the one or more personal circles in server computer memory; and
permitting access to information for a particular personal social circle of the one or more personal social circles, only to users who are on the list of members, and who log on to the internet web site.

13. The method of claim 8 further comprising
the plurality of social circles includes one or more parent circles, each of which include one or more inner circles;
and further comprising permitting a first set of members to access information concerning the one or more parent circles and the one or more inner circles via the internet web site; and
permitting a second set of members to access information concerning the one or more parent circles, but not the one or more inner circles via the internet web site.

14. The method of claim 8 further comprising
the plurality of social circles includes one or more event circles, concerning one or more events; and
further comprising providing information concerning each of the one or more event circles for only a range of time of times of occurrence of the one or more events via the internet web site.

15. The method of claim 8 wherein
the plurality of social circles include content;
wherein the content of the plurality of social circles includes content concerning one or more private social circles;
and further comprising allowing access to information concerning the one or more private social circles from the server computer via the internet to the first computer only in response to identification information provided at the first computer by a user who is both a member of the internet web site and a member of the one or more private social circles;
wherein the information concerning the one or more private social circles includes information concerning one or more inner social circles of public social circles.

16. The method of claim 15 wherein
information concerning the private social circles is stored in computer memory outside of the server computer and is accessed by the server computer via the internet using an application programming interface.

17. The method of claim 8 further comprising
assigning a ranking value in computer memory to every user that is registered on the internet web site;
wherein the ranking value relates to the authenticity of a user, and is determined based on a process executed by a computer program running on a computer processor that calculates a score, wherein the score is based on positive or negative inputs from users of the internet website.

18. The method of claim 8 further comprising
allowing access to the first user to information stored in computer memory concerning a first set of connections of a second user, wherein the first set of connections does not include all of the connections of the second user which are stored in computer memory;
allowing access to the first user to information concerning a first set of members of a first set of personal social circles of the second user stored in computer memory, if the first user is classified as a member of the first set of personal social circles, in computer memory.

19. The method of claim of 8 further comprising
allowing access to a plurality of sub accounts under a user main account.
